(19) United States
(12) Patent Application Publication
(10) Pub. No.: US 2013/0228155 A1
(43) Pub. Date: Sep. 5, 2013

(54) CYLINDER HEAD FOR INTERNAL COMBUSTION ENGINE

(71) Applicant: Ben CHAPMAN, Northamptonshire (GB)

(72) Inventor: Ben CHAPMAN, Northamptonshire (GB)

(73) Assignee: IImor Engineering Limited, Northamptonshire (GB)

(21) Appl. No.: 13/435,727

(22) Filed: Mar. 30, 2012

(30) Foreign Application Priority Data
Mar. 5, 2012 (GB) 1203817.0

(51) Int. Cl. F02F 1/24

(52) U.S. Cl. 123/470

(57) ABSTRACT

A cylinder head arrangement for an internal combustion engine, having
a combustion chamber portion for defining a combustion chamber above a cylinder in which a piston is reciprocable;
two inlet valves lying substantially to one side of the combustion chamber portion, and two exhaust valves lying substantially to the other side of the combustion chamber portion; and
a fuel injector disposed in an edge region of the combustion chamber portion at the exhaust valve side thereof, and arranged to inject fuel generally across the combustion chamber portion towards the inlet valve side thereof.

### BACKGROUND TO THE INVENTION

1. Field of the Invention

This invention relates to internal combustion engines, and more specifically to the configuration of a cylinder head of an engine and of components associated with the, or each combustion chamber thereof.

The cylinder head of an internal combustion engine, to which the invention relates, has inlet and exhaust passages which communicate with the or each combustion chamber defined between the cylinder head and the respective cylinder space therebeneath. Poppet-type inlet and exhaust valves are reciprocably supported in the cylinder head, and have heads which co-operate with seatings where the passages open into the combustion chamber, the valves being controlled to open and close the respective passages in the required timed relationship with movement of a piston in each cylinder space.

It will be appreciated that terms such as “over”, “beneath”, and the like are used herein according to engine design convention, rather than referring literally to the disposition of the respective parts which are being referred to. For example, it is accepted that an engine may have its cylinders disposed with the reciprocation axis of its piston(s) lying horizontally when installed in a vehicle for example, and yet the engine will still be referred to as having overhead cams, despite the fact that when considering the installed engine the cams are not physically located above the horizontal cylinders.

The invention relates more particularly to a spark-ignition engine of the so-called “direct fuel (or gasoline) injection” type, in which fuel is injected directly into the combustion chamber, rather than into the inlet passage(s) to enter the cylinder with air for the combustion process. Therefore, in addition to the valves, the cylinder has to accommodate a spark plug and a fuel injector, and has to provide for these components to communicate with the combustion chamber.

The invention has been devised in relation to an engine utilising the so-called “four valve” arrangement of two inlet and two exhaust valves per cylinder. This arrangement is used in many engines, especially those for automotive applications, in order to achieve currently-desirable characteristics in respect of power output, fuel economy and exhaust emissions. The four valve arrangement provides a greater valve area for flow of inlet and exhaust gases, in relation to the bore of the cylinder, than can an arrangement of only a single inlet valve and a single exhaust valve per cylinder. The most common four valve arrangement has two inlet valves disposed with their axes of reciprocation lying in a plane inclined to the centre line of the cylinder bore, the valves being spaced from one another in a direction which may be, and (in the case of a multi-cylinder engine) usually is, parallel to the rotational axes of the engine's crank shaft. The axes of reciprocation of the valves may be parallel to one another or inclined to one another. The axes of reciprocation of the exhaust valves lie in another plane which is oppositely inclined to the cylinder bore, and which intersects the plane of the inlet valve; the exhaust valves being spaced as the inlet valves and parallel or inclined to one another. The general shape of the combustion chamber is of shallow pent-roof configuration, which is desirable in enabling the required compression ratio to be achieved.

2. Description of Prior Art

In such an engine, the spark plug typically is disposed centrally or nearly centrally in the cylinder head between the heads of the valves, so that the combustion process is favourable for economy, exhaust emissions, and power characteristics. In many engines the fuel injector is similarly positioned, the aim being to achieve a favourable distribution of fuel, and mixture thereof with inlet air entering the combustion chamber.

In a modern internal combustion engine optimised for high volumetric efficiency and running speed, the bore/stroke ratio generally is relatively large. The combustion chamber shape when the piston is at or near the top of its stroke is small in the direction of reciprocation of the piston and has a large area viewed in the direction of such reciprocation. This creates difficulties in achieving good mixing of fuel of air and homogeneity of the mixture across the combustion chamber. It is broadly an object of the present invention to address such difficulties.

### SUMMARY OF THE INVENTION

According to one aspect of the invention, we provide:
a cylinder head arrangement for an internal combustion engine, comprising:
a combustion chamber portion for defining a combustion chamber above a cylinder in which a piston is reciprocable;
two inlet valves lying substantially to one side of the combustion chamber portion, and two exhaust valves lying substantially to the other side of the combustion chamber portion; and
a fuel injector disposed in an edge region of the combustion chamber portion at the exhaust valve side thereof, and arranged to inject fuel generally across the combustion chamber portion towards the inlet valve side thereof.

According to another aspect of the present invention, we provide a cylinder head for an internal combustion engine, comprising:
at least one combustion chamber portion for defining a respective combustion chamber above a respective cylinder in which a piston is reciprocable;
each combustion chamber portion having associated therewith two inlet valve seatings for co-operation with the heads of respective inlet valves, for controlling fluid flow through respective inlet passages, and two exhaust valve seatings for co-operating with head portions of respective exhaust valves for controlling flow of fluid through respective exhaust passages; wherein, as viewed in the direction of piston reciprocation, the inlet valve seatings lie substantially to one side of the combustion chamber portion and the exhaust valve seatings lie substantially to the other side of the combustion chamber portion;
and a formation for receiving a fuel injector for injecting fuel into the combustion chamber portion;
wherein the formation for receiving the fuel injector is disposed in an edge region of the combustion chamber portion at the side thereof occupied by the exhaust valve seatings, and a fuel injector arranged for injecting fuel across the combustion chamber portion towards the side thereof having the inlet valve seatings.

Viewed transversely of the central axis of piston reciprocation, the formation which receives the fuel injector may be inclined so as to face downwardly into the cylinder. Preferably the inclination is such that the injector faces the piston crown when the piston is at or in the vicinity of its top dead centre position.

### BRIEF DESCRIPTION OF DRAWINGS

These and other features of the invention will now be described by way of example with reference to the accompanying drawings, of which:

FIG. 1 is a diagrammatic sectional view looking transversely through a cylinder head and cylinder in accordance with the invention, showing the principal operative components thereof;

FIG. 2 is a diagrammatic plan view of the cylinder head shown in FIG. 1.

### DESCRIPTION OF PREFERRED EMBODIMENTS

Referring to the drawings, a cylinder head 10 is shown disposed above a cylinder 12 defined by a liner 14 within which a piston is reciprocable. A crown portion of the piston is indicated at 16, but other constructional details of the piston will be well known to the person skilled in the art and will not be referred to herein. A central axis of the cylinder is indicated at 18.

The illustrated cylinder may be one cylinder of a multi-cylinder engine, having one or more banks of cylinders each with a cylinder head covering a number of cylinders in a cylinder block.

The cylinder head 10 contacts a cylinder block, in which the liner 14 is supported, at a joint face 20. The cylinder head has a combustion chamber portion indicated at 22, facing the cylinder therebeneath and defining a combustion chamber between it and the piston crown 16. The combustion chamber portion 22 is of shallow pent-roof configuration, and fluid flow into and out of the combustion chamber is controlled by two inlet valves 24 (24a, 24b) and two exhaust valves 26 (26a, 26b). The inlet valves have stems 28 which engage in respective valve guiding formations in the cylinder head, for reciprocation along the central longitudinal axis of each stem, and heads 30 which are co-operable with valve seatings in the combustion chamber portion of the head to close respective inlet passages 32. The inlet valve seatings in the cylinder head closely adjoin one another, as visible in FIG. 2, and the axes of the valve stems of the two valves 24a, 24b lie parallel to one another in a plane extending at a small inclination to the cylinder axis 18, the centres of the valve heads being spaced chordally of the cylinder beneath the combustion chamber portion.

The exhaust valves 26 have stems and heads as those of the inlet valves 24, the heads of the exhaust valves co-operating with exhaust valve seatings in the combustion chamber portion of the cylinder head. The heads of the exhaust valves are, as is conventional in internal combustion engines, of slightly smaller diameter than the heads of the inlet valves, and lie spaced a short distance from one another in the same direction as the inlet valves 24, chordally of the cylinder parallel to the chordal disposition of the heads of the inlet valves. The stems of the exhaust valves 26 are parallel to one another, their axes lying in a plane inclined to the plane of the stems of the inlet valves and also to the central axis 18 of the cylinder. The heads of the exhaust valves 26 are operable to close respective exhaust passages 34. Typically the planes containing the axes of the inlet valves and the exhaust valves will be parallel to the rotational axis of the engine's crankshaft.

Operation of the inlet and exhaust valves, to open and close same in timed relation to engine rotation (and hence piston movement in the cylinder) may be effected and controlled by any means which will be familiar to those skilled in the internal combustion engine art.

A spark plug 36 is threadedly engaged with the cylinder head, in a formation which opens into the combustion chamber in a central region bounded by the inlet and exhaust valve seatings, slightly offset from the axis 18.

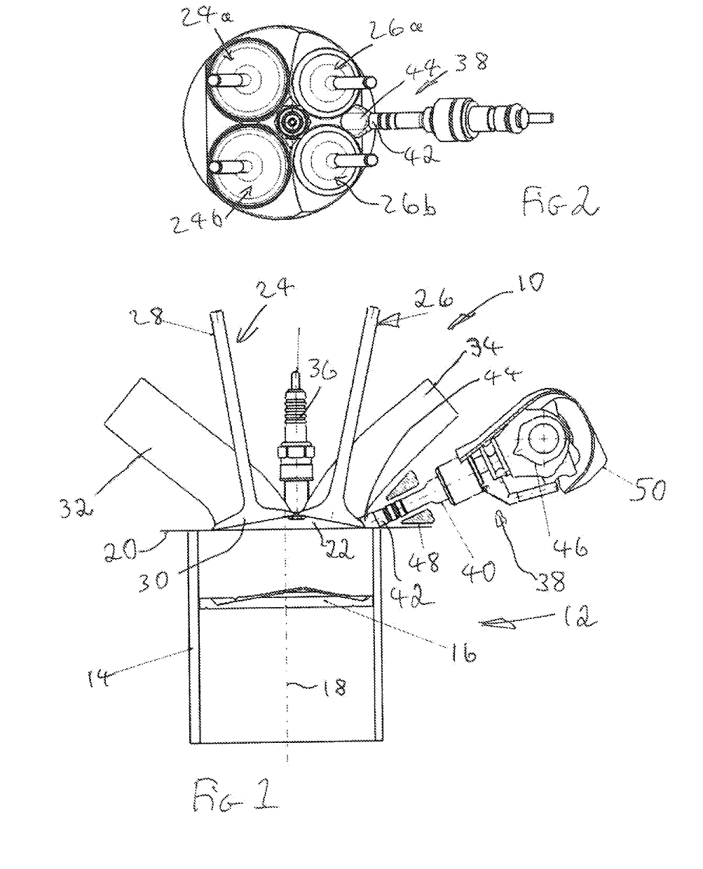

The cylinder head also has a formation for supporting a fuel injector indicated generally at 38. The fuel injector has a body 40 from whose tip 42 injected fuel is emitted through a plurality of holes in a predetermined pattern, the formation in the cylinder head which receives the body of the injector ending in a passage 44 opening into the combustion chamber 22. This is at the edge of the combustion chamber opposite the side thereof where the inlet valves 24 are disposed, in a region partially bounded by the seatings of the exhaust valves 26. In plan view the injector is disposed diametrally of the cylinder and combustion chamber, and as shown in FIG. 1 the injector is inclined downwardly by a small angle towards an upper region of the cylinder, so that the spray of fuel emitted from the injector when in use, during an injection phase, for an appropriate period of time in relation to the engine's induction stroke, is directed generally towards the piston crown or the position in the cylinder where the piston crown would lie when the piston is in the vicinity of its top dead centre position.

In the cylinder head, the body of the injector 38 lies in the region generally below, and relatively closely adjacent to, the exhaust passages as 34. A fuel rail 46 supplying fuel to the injector and adjacent injectors for other cylinders will lie, outside the cylinder head, in a region beneath exhaust pipage (e.g. an exhaust manifold or an arrangement of individual exhaust pipes) of the engine. Therefore, attention must be paid to cooling of the injector and related components such as the fuel rail. To this end, adequate liquid cooling passages as indicated at 48 are provided in the cylinder head in the vicinity of the injector body 14 and tip 42, while a heat shield 50 is shown covering the fuel rail. In use of an engine as above described, during the induction stroke the fuel spray is directed across the cylinder into the incoming air stream from the inlet valves 24. This ensures good fuel mixing with the incoming air, and good homogeneity between fuel and air is achieved across the entire with of the cylinder. It will be noted, that, by being disposed at the “exhaust” side of the cylinder, the fuel spray from the injector is not to any significant extent interfered with by the exhaust valves; the exhaust valves are either wholly closed or close to being wholly closed at the start of injection.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A cylinder head arrangement for an internal combustion engine, comprising:
a combustion chamber portion for defining a combustion chamber above cylinder in which a piston is reciprocable;
two inlet valves lie substantially to one side of the combustion chamber portion, and two exhaust valves lie substantially to the other side of the combustion chamber portion; and
a fuel injector disposed in an edge region of the combustion chamber portion at the exhaust valve side thereof, and arranged to inject fuel generally across the combustion chamber portion towards the inlet valve side thereof.

2. A cylinder head arrangement according to claim 1 comprising a spark plug disposed in a region of the combustion chamber portion bounded by the inlet and exhaust valves.

3. A cylinder head arrangement according to claim 2 wherein the fuel injector is inclined to direct fuel towards the cylinder beneath the combustion chamber.

4. A cylinder head for an internal combustion engine, comprising at least one combustion chamber portion for defining a respective combustion chamber above a respective cylinder in which a piston is reciprocable;
each combustion chamber portion having associated therewith two inlet valve seatings for co-operation with the heads of respective inlet valves, for controlling fluid flow through respective inlet passages, and two exhaust valve seatings for co-operating with head portions of respective exhaust valves for controlling flow of fluid through respective exhaust passages;
wherein, as viewed in the direction of piston reciprocation, the inlet valve seatings lie substantially to one side of the combustion chamber portion and the exhaust valve seatings lie substantially to the other side of the combustion chamber portion;
and a formation for receiving a fuel injector for injecting fuel into the combustion chamber portion;
wherein the formation for receiving the fuel injector is disposed in an edge region of the combustion chamber portion at the side thereof occupied by the exhaust valve seatings, for a fuel injector arranged for injecting fuel across the combustion chamber portion towards the side thereof having the inlet valve seatings.

5. A cylinder head according to claim 4 wherein, as viewed in the direction of piston reciprocation, the fuel injector —receiving formation faces generally diametrally across the cylinder.

6. A cylinder head according to claim 4 wherein the fuel injector is inclined so as to direct fuel towards an upper region of the cylinder beneath the combustion chamber portion.

7. A cylinder head according to claim 4 wherein the formation receiving the fuel injector opens into the combustion chamber portion in a region generally bounded by the exhaust valve seatings and an adjacent edge of the combustion chamber portion.

8. A cylinder head according to claim 4, comprising a formation for receiving a spark plug in a central region of the combustion chamber portion bounded by the inlet and exhaust valve seatings.

9. A cylinder head according to claim 4 comprising passages for flow of cooling fluid in the cylinder head including portions adjacent the formation for supporting the fuel injector.

10. An internal combustion engine having a cylinder head comprising at least one combustion chamber portion defining a respective combustion chamber above a respective cylinder in which a piston is reciprocable; each combustion chamber portion having associated therewith two inlet valves having heads co-operating with respective inlet valve seatings for controlling fluid flow through respective inlet passages, and two exhaust valves having heads co-operating with respective exhaust valve seatings for controlling flow of fluid through respective exhaust passages;
wherein, as viewed in the direction of piston reciprocation, the inlet valve seatings lie substantially to one side of the combustion chamber portion and the exhaust valve seatings lie substantially to the other side of the combustion chamber portion;
and a fuel injector received in the cylinder head for injecting fuel into the combustion chamber portion;
wherein the fuel injector is disposed in an edge region of the combustion chamber portion at the side thereof occupied by the exhaust valve seatings, and is arranged to inject fuel across the combustion chamber portion towards the side thereof having the inlet valve seating.

11. An internal combustion engine according to claim 10 wherein the fuel injector injects fuel generally diametrically across the cylinder.

12. An internal combustion engine according to claim 11 wherein the fuel injector is inclined to direct fuel towards an upper region of the cylinder beneath the combustion chamber portion.

13. An internal combustion engine according to claim 10 wherein the fuel injector occupies a region of the combustion chamber portion generally bounded by the exhaust valve seatings and an adjacent edge of the combustion chamber portion.

14. An internal combustion engine according to claim 10 comprising a spark plug in a central region of the combustion chamber portion bounded by the inlet and exhaust valve seatings.

15. an internal combustion engine according to claim 10 comprising exhaust pipage extending from the exhaust passages in the cylinder head, and further comprising a heat shield between the fuel injector and the exhaust pipage.
